(19) United States
(12) Patent Application Publication
(10) Pub. No.: US 2003/0009409 A1
(43) Pub. Date: Jan. 9, 2003

(54) Systems and Methods for providing risk/return measures for securities lending programs

(76) Inventors: Glenn Horner, Norfolk, MA (US); Edward J. O'Brien, Sudbury, MA (US); Ralph F. Vitale, Boxford, MA (US); Susan G. Fay, Reading, MA (US); Peter A. Economou, Hanover, MA (US); Margaret M. Radzik, Hanover, MA (US)

Correspondence Address: ROPES & GRAY, ONE INTERNATIONAL PLACE, BOSTON, MA, 02110-2624, US

(21) Appl. No.: 10/160,937

(22) Filed: May 31, 2002

Related U.S. Application Data
(60) Provisional application No. 60/295,450, filed on Jun. 1, 2001.

(51) Int. Cl. G06F 17/60

(52) U.S. Cl. 705/36

(57) ABSTRACT

The systems and methods described herein provide Web based tools that allow a custodial bank or other institution to provide their security lending customers or prospective customers with tools for analyzing different risks/return scenarios. To this end, these Web-based systems may lead a security holder through a process wherein the security holder creates a profile that describes the different types of securities within their portfolio and describes the allocation of the security assets among different asset classes. The Web-based processes are capable of generating graphical images of the estimated earnings and certain risks present in a securities lending transaction, to thereby present to the security holder a visual representation of the information the holder needs to make an informed investment decision.

This application claims priority to an earlier filed provisional patent application of same title, filed Jun. 1, 2001, U.S. Provisional Application No. 60/295,450 and naming Glenn Horner as an inventor.

### FIELD OF THE INVENTION

The systems and methods described herein include systems for managing investment portfolios and for determining an allocation of assets to generate a desired rate of return consonant with the recognition of specified risk avoidance criteria.

### BACKGROUND OF THE INVENTION

Institutional investors such as pension funds, insurance companies and mutual funds are typically long-term holders of debt and equity securities. For regulatory and other reasons, institutions such as State Street Corporation often hold these securities in a custodial capacity. While gains may be realized from sales of these securities, they otherwise generally represent idle assets for owners and their custodians.

Securities lending thus emerged as an effective way to earn additional revenue on an existing portfolio of securities. In a securities lending transaction, a security lender, often acting through its custodian as its lending agent, loans a security to a security borrower on a short-term basis. The borrower provides collateral for the loan, consisting of either cash or other securities. The collateral is typically cash, in which case the lender pays a “rebate” to the security borrower for the use of the cash. The rebate represents a financing cost for the security lender and is generally below the current effective federal funds rate. A securities lender may then realize revenue by reinvesting the cash collateral in interest bearing investment vehicles and earning an amount greater than the rebate that is paid to the borrower. If other securities are received as collateral, the borrower pays a fee, referred to as a “premium”, for the use of the borrowed securities. The securities borrower may then engage in desired transactions using the borrowed securities. A securities lending transaction is concluded when the securities are returned to the lender and the collateral is returned to the borrower. In theory, these transactions work well for all participants and provide the ability to receive low cost financing for investments in low risk reinvestment vehicles, thus yielding enhanced risk-adjusted returns.

However, no financial transaction is without risk and even a securities lending transaction involves some level of risk. As always investors are well served when they are informed of the risks they may be taking when participating in a financial transaction. This is true because an informed investor can use risk as a factor that can increase return, or as a factor that can be controlled to reduce the likelihood of loss. Yet today, service providers that offer securities lending programs lack a facile way to convey to participants what risk may be involved in the transaction. The difficulties with describing the risks arise, in part, from the fact that securities lending is a somewhat complex transaction and even some very skilled financiers fail to understand all the subtle factors that may influence the risk present in a securities lending transaction. Moreover, even those skilled financiers that understand these risks are challenged by the difficulty of conveying these risks in a way that keeps the information concise, meaningful and current.

Accordingly, there remains a need for a securities lending system that permits informed risk measurement for securities lenders to enable lenders to better inform the lending agent to understand the risk and return preferences of the lender.

### SUMMARY OF THE INVENTION

There are risks involved in every investment activity, including securities lending. For security holders to be able to more effectively evaluate certain of these risks, the systems and methods described herein provide, inter alia, tools that graphically depict certain of the risks that arise from investing cash collateral during a securities lending transaction. Accordingly, the systems and methods described herein provide tools that allow a security holder to analyze different risk and return profiles for the possible cash collateral investments available within a securities lending program.

More particularly, the systems and methods described herein provide, in one embodiment, Web based tools that allow a custodial bank, a web based marketplace or other entity to provide their security lending customers or prospective customers with tools to analyze different risk/return scenarios. To this end, these Web-based systems lead a security holder through a process wherein the security holder creates a profile that describes the different types of investments within its portfolio of investments (purchased with the cash collateral delivered to the lender in connection with securities lending transactions) and the allocation of the portfolio investments among different asset classes or types. In a further step, these Web-based systems may allow the security holder to identify a tolerance for risk relating to the investment of the cash collateral. Further, given the amount and types of securities held by a security lender, the on-loan balance may be estimated. The process may then estimate, for the amount of on-loan balances and for the security holder's tolerance for risk, the earnings that may be obtained by investing the cash collateral. The Web-based processes are capable of generating graphical images of the estimated earnings to thereby present to the security holder a visual representation of the estimated earnings. The generated graphical image may comprise a standard Web page that can be delivered to a client application run by the security holder.

The information presented in these generated Web pages allows a security lender to make more informed decisions. For example, the Web pages may provide graphical representations of how different factors contribute to the estimated earnings. These examples may include depictions of the portion of the estimated earnings that arise from demand spread, or from collateral reinvestment. Additionally, the system may depict how tolerance for risk effects estimated earnings by depicting estimated earnings for a number of different risk tolerances.

In addition to the visual representation of the estimated earnings, the Web-based system may include a process that identifies certain of the risks, including the cash collateral investment, risks the security holder is taking when participating in a security lending program. This process may include steps for determining the risk that the net asset value of the collateral reinvestment may decline, as well as the risk that earnings for the securities lending program will vary over time. Again, to provide the security holder with tools for easily analyzing these risks, these processes may generate graphical images that visually present to the security holder this risk, including net asset value and spread risk.

Further, the systems described herein may allow a user to identify a tolerance for risk. Based on the selected tolerance for risk, the systems may identify a set of investment vehicles having risk factors consistent with the selected risk tolerance. The system may determine for the identified set of investment vehicles the risk that arises from investing the collateral and the spread risk associated with the excess return on the identified investment vehicles. All this information may also be graphically presented.

Other uses, additions and modifications to the systems and methods described herein will be apparent from the following description of certain illustrated embodiments.

### BRIEF DESCRIPTION OF THE DRAWINGS

The foregoing and other objects and advantages of the invention will be appreciated more fully from the following further description thereof, with reference to the accompanying drawings wherein;

FIGS. 1A-C depict prior art processes for performing a securities lending transaction;

FIG. 2 depicts a system according to the invention allowing for security holders to analyze certain of the risks arising during a securities lending transaction;

FIG. 3 depicts in more detail the system of FIG. 2;

FIGS. 4-6 depict one set of user interface forms suitable for use with the system of FIG. 2;

FIGS. 7-10 depict one series of output screens that present information to a subscriber on possible earnings performance; and

FIGS. 11-17 depict one series of output screens that present information to a subscriber regarding levels of certain risks present in a securities lending program.

### DESCRIPTION OF THE ILLUSTRATED EMBODIMENTS

To provide an overall understanding of the invention, certain illustrative embodiments will now be described, including a system that allows a security holder to visualize certain of the risks undertaken as a participant in a securities lending program. However, it will be understood by one of ordinary skill in the art that the systems and methods described herein can be adapted, added to and modified for other applications, and realized through different embodiments, and that such other applications, additions and modifications build on and are encompassed within the scope hereof.

Because the embodiments that have been chosen to illustrate the systems and methods of the invention relate, at least in part, to securities lending programs, for purposes of clarity and illustration an example of a securities lending transaction will be presented below along with a glossary of certain terms that are commonly used when describing such a transaction. However, it will be understood that the example and the terms are being provided merely for the purpose of describing the systems and methods of the invention so as to enable one of ordinary skill in the art to make and use the invention and are not to be understood as limiting in any way.

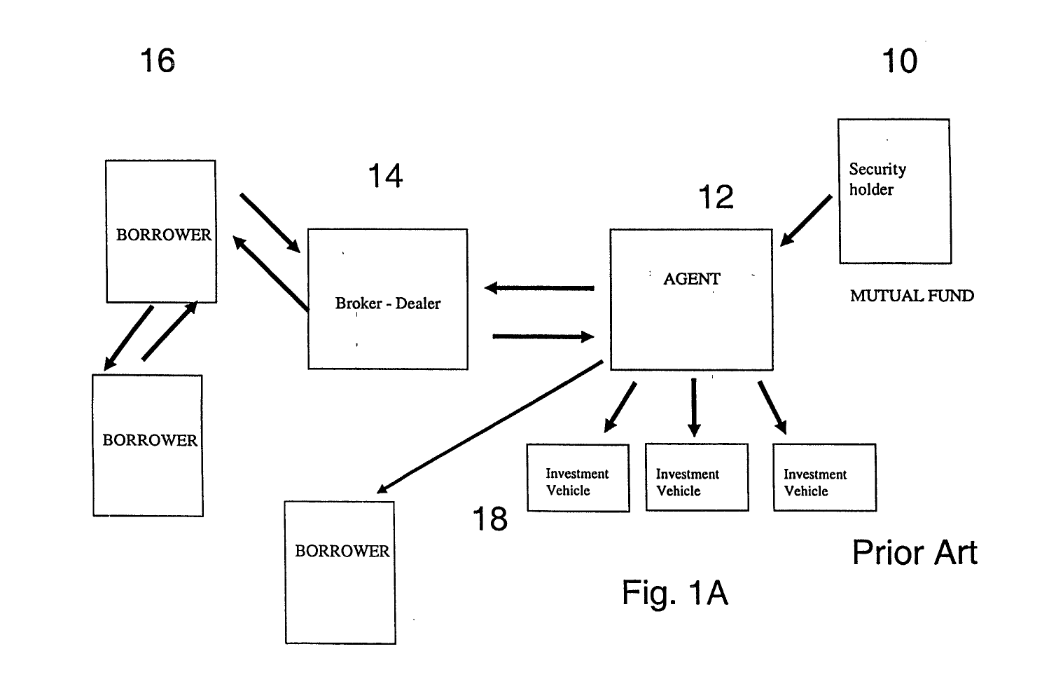

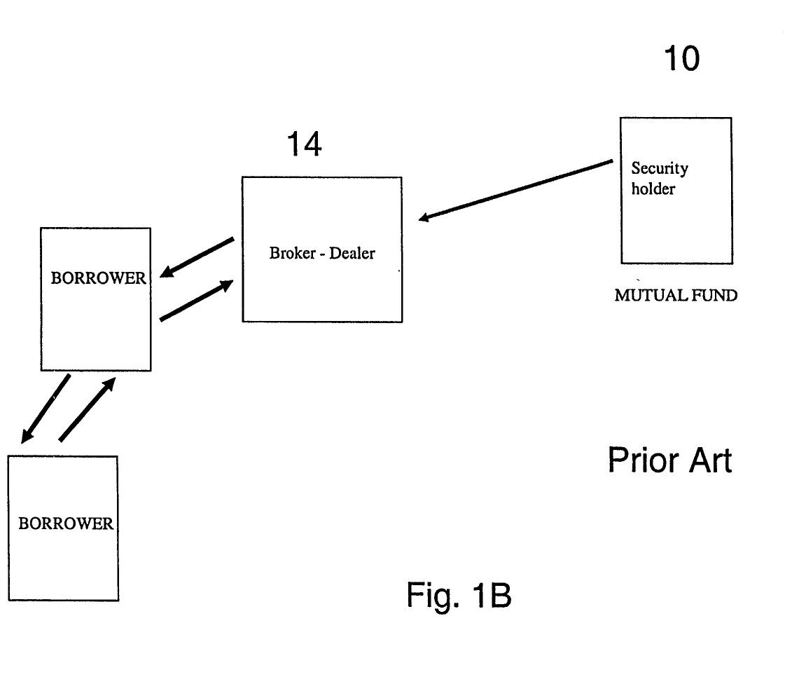

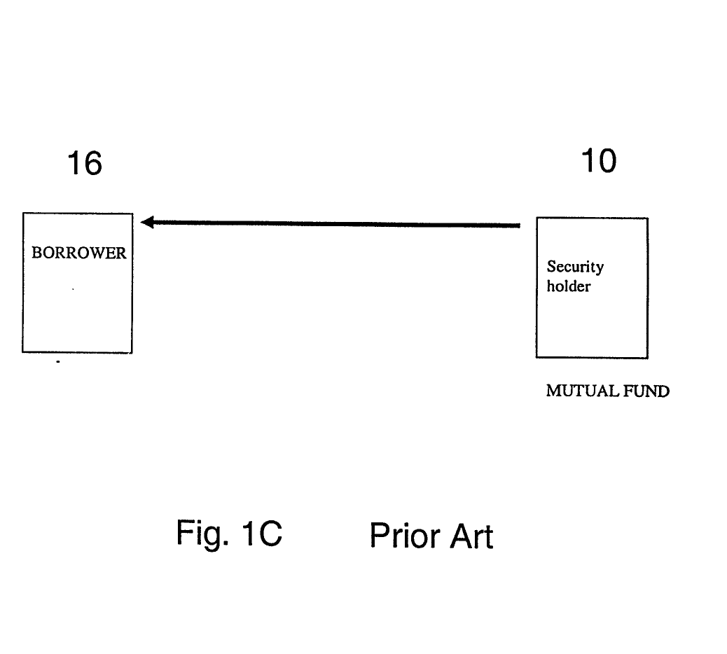

FIGS. 1A-C depict diagrammatically examples of securities lending transactions and in particular, illustrate the entities that may be involved in such transactions and the different roles these entities may play. It will be understood that the systems and methods described herein may be practiced with any of the existing securities lending programs, including those depicted in FIGS. 1A-C to provide clients with information about the risk present in a security lending transaction and to provide information about how different tolerances for risk can adjust the return realized from such a transaction. Additionally, it will be understood by those of skill in the art that the transactions depicted in FIGS. 1A-C are merely examples of the types of transactions that can benefit from the systems and methods described herein, and that the systems and methods may be employed to enhance other forms of securities lending transactions, including but not being limited to auction based transactions.

To this end, FIG. 1A illustrates an example securities lending transaction by providing a block diagram that illustrates the participants involved in the transaction and the flow of money and securities between the participants. FIG. 1A depicts a transaction wherein a security holder 10, such as pension fund or some other institution that holds a loanable interest in a security, employs an agent 12, such as a custodial bank, to loan, lease, assign, or otherwise put into the marketplace a valuable right in the security. As will be explained in greater detail below, the agent 12 can deliver an interest in the security to a borrower 14 who, in turn, can deliver an interest in the security to another borrower 16. The borrower 14 may deliver cash collateral to the lender's agent 12. The cash collateral delivered may be invested in one or more investment vehicles 18, which in this case are provided by the lender's agent 12.

As shown in FIG. 1A, a securities lending transaction typically begins with the loan of securities against the receipt of collateral generally valued at 102% or 105% of the market value of the loaned securities. The motivation for the transaction may be that a broker-dealer 14 wishes to sell short a particular stock. To sell the stock short, the broker-dealer 14 borrows, for example, 1000 shares of the stock and sells them into the market. If the stock loses value, the broker-deal 14 can make a gain by subsequently purchasing 1000 shares of the stock sold short, for redelivery to the lender's agent 12, at a price less than the shares were sold short. To this end, the broker-dealer 14 can contact a security holder 10 or an agent 12 for a security holder 10 and borrow the 1000 shares. As part of the loan, the broker-dealer 14 delivers the collateral to the lender 10 or its agent 12. U.S. dollar cash is the predominant form of collateral. However, cash denominated in certain other currencies, such as Euros and Yen, and certain securities may also be accepted as collateral. The market values of the loaned securities and collateral may be monitored daily and the broker-dealer 14 may be required to post additional collateral to the extent the collateral value falls below the required level. Loaned securities and collateral are generally transferred simultaneously. To the extent that they are not, receipt of collateral is typically confirmed prior to the release of the loaned securities.

If cash collateral is posted by the broker-dealer 14, the lender 10, often acting through the agent 12, is generally required to pay a rebate, or interest charge, to the broker-dealer 14 for its use. The lender 10, or its agent 12, are normally able to invest the cash collateral and earn an amount greater than the rebate. Thus, the lender 10 now has incurred a financing cost by lending securities to a broker-dealer 14. However, since this financing cost is typically below the return available on nearly risk free investments, for example the return provided by the effective federal funds rate, income is typically generated by investing the cash collateral in higher yielding short term investment portfolios. The level of the rebate rate is related to the demand for the security relative to its supply. In those situations where securities are posted as collateral, a fee is paid by the broker-dealer 14. The fee will generally be at a level that approximates the difference between the cash rebate that would have been paid relative to a nearly risk free rate.

The cost of the loan to the broker-dealer 14 in the case where cash is posted as collateral is the difference between the rebate received and the rate it could earn in an overnight investment. This “opportunity cost” represents the borrowing cost. The lender 10 or its agent 12 then reinvests the cash collateral into a short-term fixed income portfolio. Generally, the reinvestment portfolio will have a longer duration than the term of the loan portfolio, thus creating an asset and liability mismatch. Income is earned by the lender 10 and its agent 12 as a result of by the difference, or spread, between the rebate rate and the yield on the reinvestment of the cash collateral. This income is split between the agent 12 and the lender 10 at a pre-agreed upon rate. However, the asset and liability mismatch creates an interest rate risk that can impact both future earnings and the net asset value of the collateral reinvestment fund.

The above described securities lending transaction, illustrated in FIG. 1A is only one example of the type of securities lending transaction that can occur and to which the systems and methods of the invention can be applied. The systems and methods described herein may be employed with any of the many types of securities lending transactions, including transactions where the number and type of participants differ. For example, FIG. 1A depicts a transaction wherein the actual holder of securities (the lender 10) employs an agent 12 or custodian to actually participate in the transaction. However, the use of such agents, although typically done and quite efficient, is optional and in other example transactions there may be more or fewer parties. For example, FIG. 1B depicts a securities-lending transaction where the security holder 10 deals directly with the broker-dealer 14. In such transactions no agent is employed, however, the basics of the transaction still occur as described above with reference to FIG. 1A, except that security holder 10 deals directly with the broker-dealer 14 and is directly responsible for maintaining its accounts and negotiating with the broker-dealer 14 during the transaction. To maintain sufficient deal flow, the depicted broker-dealer may operate an auction site that allows security holders to post the securities it has available for lending, and to allow interested borrowers 16 to bid for the securities. FIG. 1C depicts a further example of a securities lending transaction where the security holder 10 deals directly with the actual borrower 16. In this case, the security holder 10 directly participates in the marketplace for loaned securities, and may have a stable of clients and customers for its securities, or may be part of a cooperative that has created such a marketplace. Further, the systems and methods described herein may be applied to other applications such as the risk adjusted return of short term fixed income portfolios or money market funds, including other lending transactions where cash is provided as collateral.

However, regardless of the type or form of transaction undertaken, both the agent 12 and the lender 10 are motivated to achieve the highest yield possible for the reinvested cash collateral. At the same time, the lender 10 and agent 12 are motivated to understand risk, avoid unwarranted risk and reduce the likelihood that value of the investments made with the cash collateral decreases, as this will represent an economic loss to both the lender 10 and agent 12. Furthermore, if the lender 10 needs to sell reinvested assets to raise cash in order to return cash collateral to the broker-dealer 14, it could potentially realize a loss.

For a long time, securities lending transactions were generally considered risk free. However, in the recent past certain lenders and agents experienced losses that arose from certain risk factors present in the securities lending transaction. Risk in securities lending originates in the two major components of the transaction: the lending of securities to counterparts against the receipt of collateral and the subsequent reinvestment of the cash collateral received.

Thus there is risk that can arise from participating in a securities lending program. To address this risk, the systems and methods described herein allow a participant in a securities lending program, or another type of transaction, to visualize certain of the risks involved in the program and to evaluate these risks in relation to the possible returns that may be gained.

To aid in the following description of the systems and methods, the following terms are presented. However, these terms are presented for the purpose of clarifying the described systems and methods and are not to be understood as terms that limit or constrain the inventive subject matter in any way.

Accrued Interest—Describes interest that has accumulated between the most recent payment of interest and the current date.

Agent—Describes a firm that executes orders for, or acts on behalf of, another party (the principal). An agent does not have title to the principal's property, and owes a duty of obedience to the principal's orders. A related term is agent bank.

Arbitrage—Technically, the process of buying a security, commodity or currency in one market and selling immediately in another market at a higher price in order to earn a riskless profit from temporary price differentials between two markets. This definition can be expanded to include the purchase of a relatively underpriced asset or the sale of a relatively overpriced asset with the expectation of profiting once the relationship returns to a more theoretical or historical relationship. See the “Dictionary of Financial Risk Management” Gastineau and Kritzman, Frank J. Fabozzi Associates (1996).

Basis Point—One one-hundredth of a percent.

Collateral—Cash or other assets pledged to a lender as security until a loan is terminated. The most common forms of collateral in securities lending are cash, equities, letters of credit, U.S. government and agency bonds, other financial securities.

Credit Risk—In securities lending, the possibility that a borrower may default on its obligations to return the borrowed security and the collateral is insufficient to purchase in the open market the securities on loan.

Demand Spread—In securities lending, represents the spread to the risk free rate arising from the market demand for a certain security, a certain type of security or securities in general.

Hedge—A position or combination of positions that reduces some type of risk, usually at the expense of expected reward. In a narrower sense, the term often applies to offsetting a long position in one security with a short position in a similar security. See the “Dictionary of Financial Risk Management” Gastineau and Kritzman, Frank J. Fabozzi Associates, 1996.

Margin—The amount or percentage by which collateral value exceeds the market value of the loaned security. The lender of securities will typically require a margin of 2% on domestic loans (102%) and 5% on foreign loans (105%).

Rebate—The rate of interest paid to a borrower with respect to the cash collateral posted by such borrower in connection with a securities lending transactions. The rate varies depending on the borrower, the securities onloan and the and current short-term interest rates.

Reinvestment Spread—In securities lending, represents the difference between the yield earned on a collateral reinvestment vehicle and the risk free rate.

Short Sale—A transaction in which a market participant sells a security that it does not own either with the expectation that the price of the security will fall or as part of a hedging strategy. A broker-dealer or other market participant may borrow the needed security on a temporary basis to effect settlement. Eventually, however, the broker/dealer must purchase the security to redeliver the borrowed security.

Total Spread—In securities lending, the difference between the rate received on the investment of cash collateral and the rebate rate of a loan. Total spread may be understood as the sum of the demand spread and the reinvestment spread.

Other terms and phrases may be used herein to describe the illustrated systems and methods, and such terms will be understood from specification and from descriptions of such financial transactions in references such as the “Dictionary of Financial Risk Management” Gastineau and Kritzman, Frank J. Fabozzi Associates, 1996.

As described above, a securities lending transaction involves financial risk to the lender of securities, the lender's agent, the broker-dealer and the borrower. To this end, the systems and methods described herein provide tools that allow a security holder to consider and analyze certain of the risks involved in a securities lending program. These tools include, inter alia, web based tools that allow a lender 10 or a prospective lender to create a profile of the lender's loanable securities and the collateral that may be available to that lender 10. The systems and methods further create an estimate of the possible returns on the invested collateral and a risk profile/analysis for the invested collateral. Further, the systems and methods described herein include a risk/return analyzer that allows a lender 10 to estimate the return achieved by that lender 10 in comparison to the risk and return that may be achieved by alternative investment strategies, including strategies that involve different levels of risk.

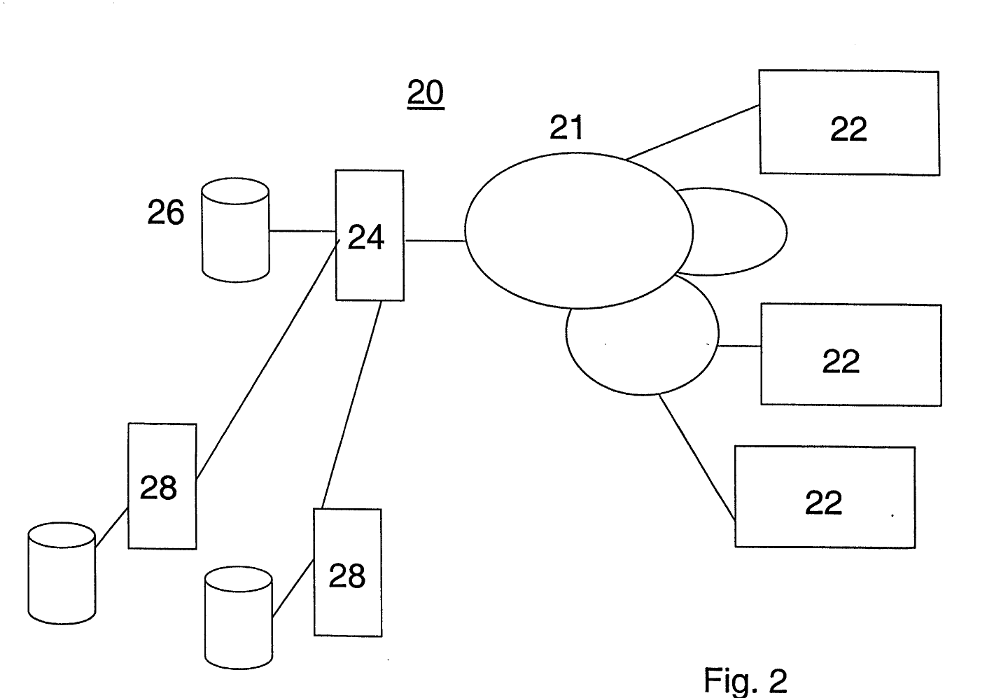

FIG. 2 depicts one embodiment of a system 20 that allows a lender 10 to subscribe to a service offered by a securities lending agent or some other entity that analyzes certain of the risks and the return that has resulted or may result from such a securities lending program. Specifically, FIG. 2 illustrates a system 20 wherein a plurality of subscriber systems 22 connect through a network 21 to the server 24. The server 24 connects to a proprietary database 26 maintained by the server 24 and similarly connects, optionally by direct secure lines, to a plurality of financial service providers 28. The elements of the system 20 may include commercially available systems that have been arranged and modified to act as a system according to the invention. The depicted system 20 of FIG. 2 employs the Internet 21 to allow a subscriber at a remote client, the subscriber systems 22, to access a central server, the depicted central server 24, to login to an account maintained by that server 24, and to employ the services provided to that account to create a profile of the securities held by that subscriber and available for lending, and to analyze the certain of the risks and the returns associated with using those assets in a securities lending program.

Turning now to the elements that comprise the system 20 depicted in FIG. 2, it can be seen the system 20 includes a network based system that includes a number of subscriber systems 22 that connect through a network 20, such as the Internet IP network or any other suitable network, to a server system, such as the server system 24 depicted in FIG. 2. In this embodiment, the server 24 also connects over dedicated channels or the Internet, or by other means, to the systems 28, which may be third-party service providers that provide databases of information, financial analysis services, transaction processing or other services that support the server 24 in analyzing the risk/return issues that arise for a particular subscriber when participating in a securities lending program.

For the depicted system 20, the subscriber systems 22 may be any suitable computer system such as a PC workstation, a set top box, a handheld computing device, a wireless communication device or any other such device equipped with a network client capable of accessing a network server and interacting with the server to exchange information with the server. In one embodiment, the network client is (i) a web client, such as the Netscape web browser, the Microsoft Internet Explorer web browser, the Lynx web browser, or a proprietary web browser, or (ii) a client application that allows the user to exchange data with a web server, ftp server, gopher server or some other type of network server. Additionally, in certain other embodiments the systems and methods described herein can include server systems that also act as clients for interacting with the server 24. In these embodiments, the server systems can support an institution or other entity that may have a substantial number of lenders that could benefit from the services provided by the server 24.

Optionally, the client and the server may rely on an unsecured communication path, such as the Internet, for accessing services on the remote server 24. To add security to such a communication path, the subscriber systems 22 and the server 24 may employ a security system, such as any of the conventional security systems that have been developed to provide to a remote user a secured channel for transmitting data over the Internet. One such system is the Netscape secured socket layer (SSL) security mechanism that provides to a remote user a trusted path between a conventional web browser program and a web server. Therefore, optionally and preferably, the subscriber systems 22 and the server system 24 have built in 128 bit or 40 bit SSL capability and can establish an SSL communication channel between the subscriber systems 22 and the server 24. Other security systems can be employed, such as those described in Bruce Schneir, Applied Cryptography (Addison-Wesley 1996). Alternatively, the systems may employ, at least in part, secure communication paths for transferring information between the server 24 and the subscriber systems 22. For purpose of illustration, however, the systems described herein, including the system 20 depicted in FIG. 2 will be understood to employ a public channel, such as an Internet connection through an ISP or any suitable connection, to connect the subscriber systems 22 and the server 24.

The server 24 may be supported by a commercially available server platform such as a Sun Sparc™ system running a version of the Unix operating system and a server program capable of connecting with, or exchanging data with, one of the subscriber systems 22. In the embodiment of FIG. 2, the server 24 includes a web server, such as the Apache web server. The web server component of the server 24 listens for requests from subscriber systems 22 and, in response to such a request, resolves the request to identify a filename, or script, that can be associated with that request and to return the identified data to the requesting subscriber system 22. The operation of the web server component of the server 24 can be understood more fully from Laurie et al., Apache The Definitive Guide, O'Reilly Press (1997). The server 24 may also include components that extend its operation to accomplish the financial transactions and processes described herein, and the architecture of the server 24 may vary according to the application. For example, the web server may have built in extensions, typically referred to as modules, to allow the server 24 to perform operations that facilitate the transactions and analysis desired by a subscriber, or the server 24 may have access to a directory of executable files, each of which may be employed for performing all or part of the operations, that implement the processes described herein.

The server 24 may couple to a database 26 that stores information representative of performance data for investment vehicles available to the subscriber. This information allows an earnings estimator module to generate information indicating spread, risk valuation, spread variability and other factors for each portfolio option. The performance data for collateral reinvestment vehicles can include historical quarterly performance reports of the collateral reinvestment vehicles available to the lender 10 or its agent 12. For example, the performance data can include earnings data by quarter for the last two, three or five years for each available collateral reinvestment vehicle. The data indicating demand spread and on loan percentages for different types of securities can come from a third party data aggregator. One such third party data aggregator is Risk Management Associates (RMA). These organizations collect data from a number of different securities lending institutions. The collected data is used to generate composite data representative of the industry's average parameters. Additionally, the database 26 can store information about a subscriber's account, including the subscriber's profile, information about the different financial service providers that the subscriber employs and, for some optional embodiments, information regarding the subscriber's accounts, including passwords, user accounts, user privileges and similar information.

The depicted database 26 may comprise any suitable database system, including the commercially available Microsoft Access database, and can be a local or distributed database system. The design and development of database systems suitable for use with the system 20, follow from principles known in the art, including those described in McGovern et al., A Guide To Sybase and SQL Server, Addison-Wesley (1993). The database 26 can be supported by any suitable persistent data memory, such as a hard disk drive, RAID system, tape drive system, floppy diskette or any other suitable system. The system 20 depicted in FIG. 2 includes a database 26 that is separate from the server 24. However, it will be understood by those of ordinary skill in the art that in other embodiments the database 26 can be integrated into the server 24.

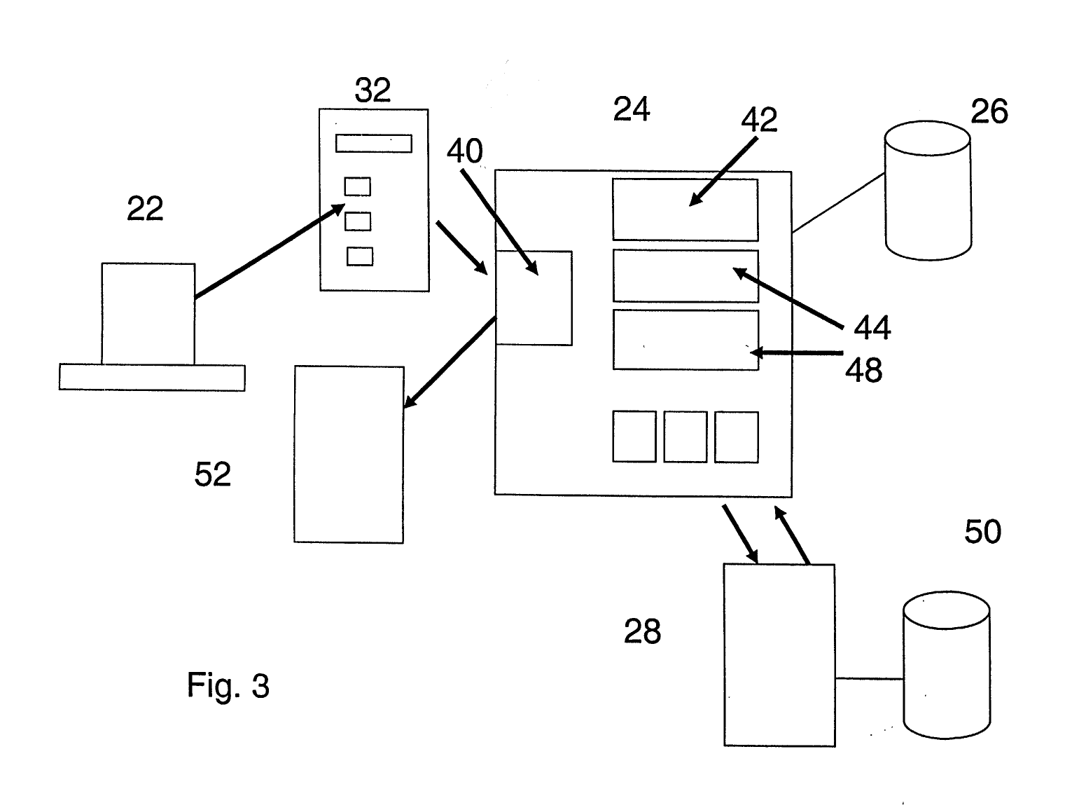

FIG. 3 provides a functional block diagram of one server 24 for analyzing risk/return performance and further depicts the data flow diagram of one example of a subscriber's use of the server 24 to perform such an analysis. Specifically, FIG. 3 depicts a data flow diagram wherein a subscriber employs a user interface 32 to provide user input to the server 24. The server 24 is shown as a functional block diagram that includes a web server 40, a profile generator module 42, a return estimator 44 and a risk estimator 48. The web server 40 can be any suitable web server, as discussed above, and in this example, can be understood as the Apache web server listening to port 80 and having access to a set of executable files stored in a directory accessible to the web server 40, such as the cgi-bin directory.

One such executable file may be the profile generator module 42 that generates the profile of securities for the subscriber. To this end, the module 42 may be a script or executable program that creates a user interface, such as the depicted interface 32. In one practice, the user interface 32 comprises an HTML form that the subscriber may complete to provide the information that the module 42 will employ. The module 42 may be an Apache module, a Perl V script, a C language program or any other suitable program for providing a process that can determine, in response to information provided by the subscriber, an access level to grant to the subscriber.

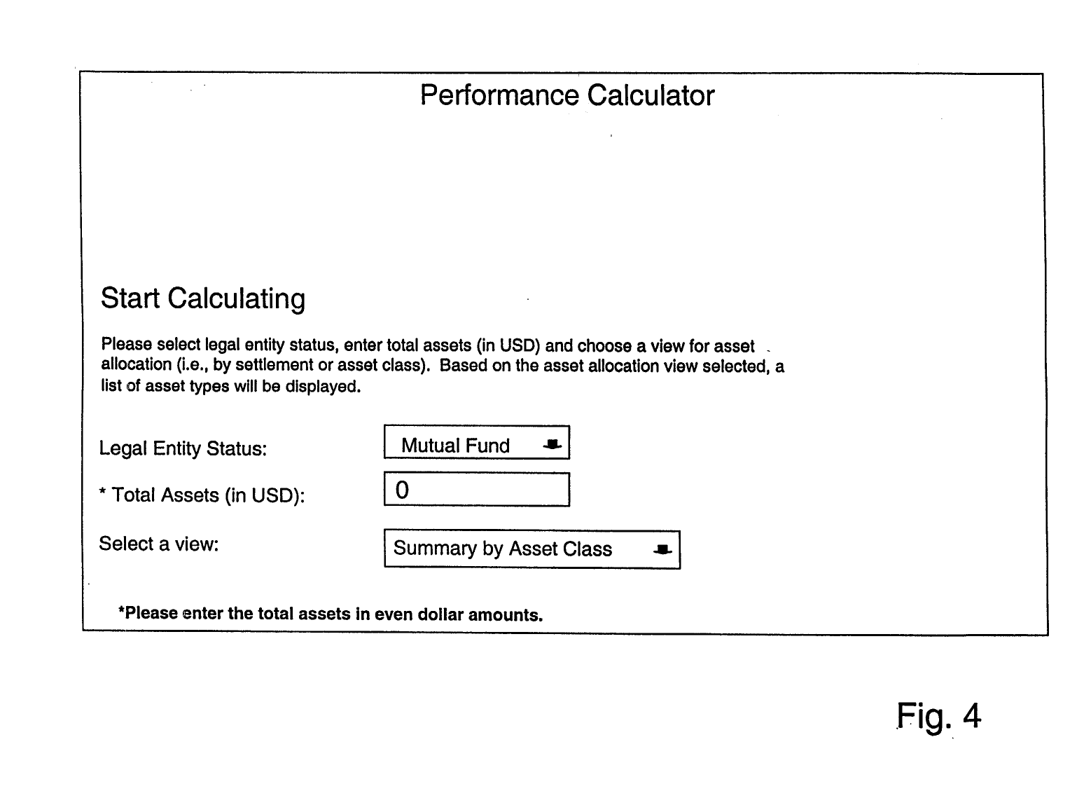

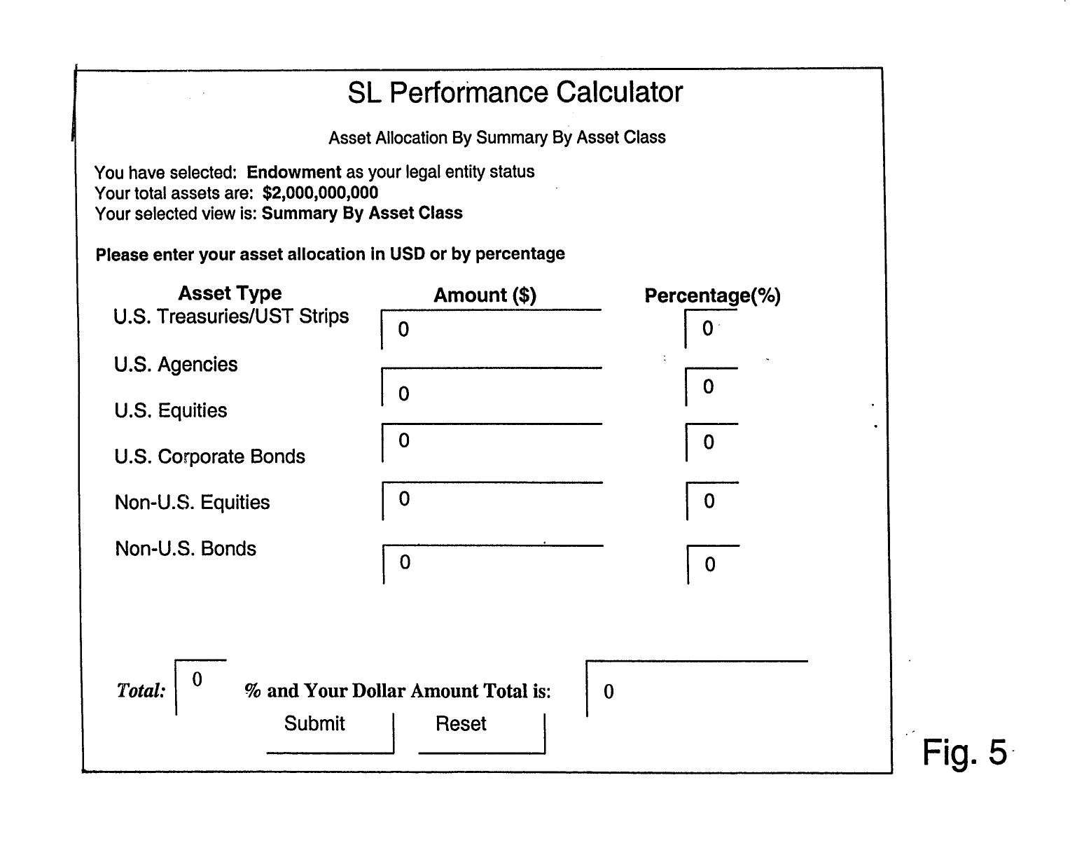

One example of a user interface 32 suitable for use with the system 20 of FIG. 2 is depicted in FIGS. 4 and 5. Specifically, FIGS. 4 and 5 present two HTML forms that allow a subscriber to enter information that is representative of the legal entity status of the subscriber and the different types of securities held by the subscriber, as well as the relative percentages of these asset types. Once this information is provided, the subscriber can deliver the form input to the server 24. The server 24 can present the information to the module 42. The module 42 can process the input to generate a profile for the subscriber. Additionally, the module 42 may process the input by accessing a database of information that has either been compiled for use by the module, or that is provided by a third party source. In the embodiment depicted in FIG. 3, the module 42 may access a service provider 28. The service provider 28 in this embodiment may include a database 50 that includes information that may be used to determine percentage of loan data that can indicate the portion of a particular asset type that may be loaned to provide collateral for subsequent investing. In one practice, the third party service may be provided by RMA that publishes a securities lending industry composite on a quarterly basis. RMA releases an aggregate data survey each quarter that covers data provided by a number of financial institutions. The listing of institutions appears on the composite report. Survey data is presented for primary lending markets worldwide, with cash-collateral reinvestment data aggregated to reflect reinvestment return, interest-rate sensitivity, liquidity, credit tiering and instrument types. The information from RMA may be gathered by a file transfer from the web site, or may be otherwise obtained to build a database that can be accessed by the server 24. The particular option employed will depend in part upon the application and the design choices of the system architect. Other information may be collected from the third party service 28 including information representative of the demand spread for the assets types, as well as the reinvestment spread for the asset types.

In one practice the demand spread is determined by processing information provided by the third party service. This information may be modified to adjust or normalize the spread rate so that data is calculated using a selected rate, such as the overnight US treasury rate instead of the rate employed by the service. Other similar adjustments can be made to provided data, and such adjustments are deemed to be within the scope of one of skill in the art.

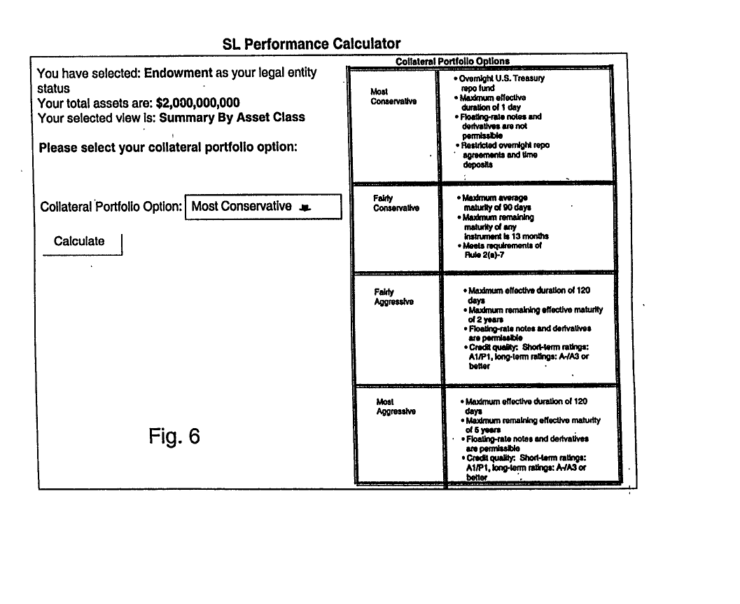

Optionally, the user interface may also include a screen, such as the screen depicted in FIG. 6, that allows the subscriber to indicate a tolerance for risk. As shown in FIG. 6 the screen presents several options that present qualitative representations of the risk involved and the types of investments that may be made as part of a collateral investment vehicle designed to accommodate that level of risk tolerance. Once this option is selected, the user interface can deliver this information to the server 24 for use by the module 42.

The design and development of the user interface generator module 42 follows from principles known in the art of computer programming, including those set forth in Wall et al., Programming Perl, O'Reilly & Associates (1996); and Johnson et al, Linux Application Development, Addison-Wesley (1998). Additionally, in other embodiments, the user interface generator module 42 can be implemented, at least in part, by employing the operating system to restrict the execution of certain scripts and to restrict access to certain files by configuring the operating system in a selected manner. Techniques for so configuring the operating system are known in the art, including those techniques set forth in Bach, The Design of the Unix Operating System, Prentice-Hall (1986).

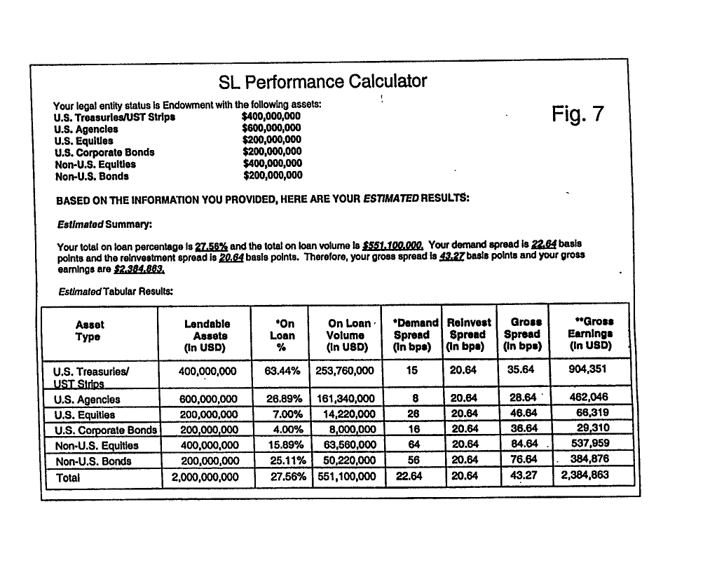

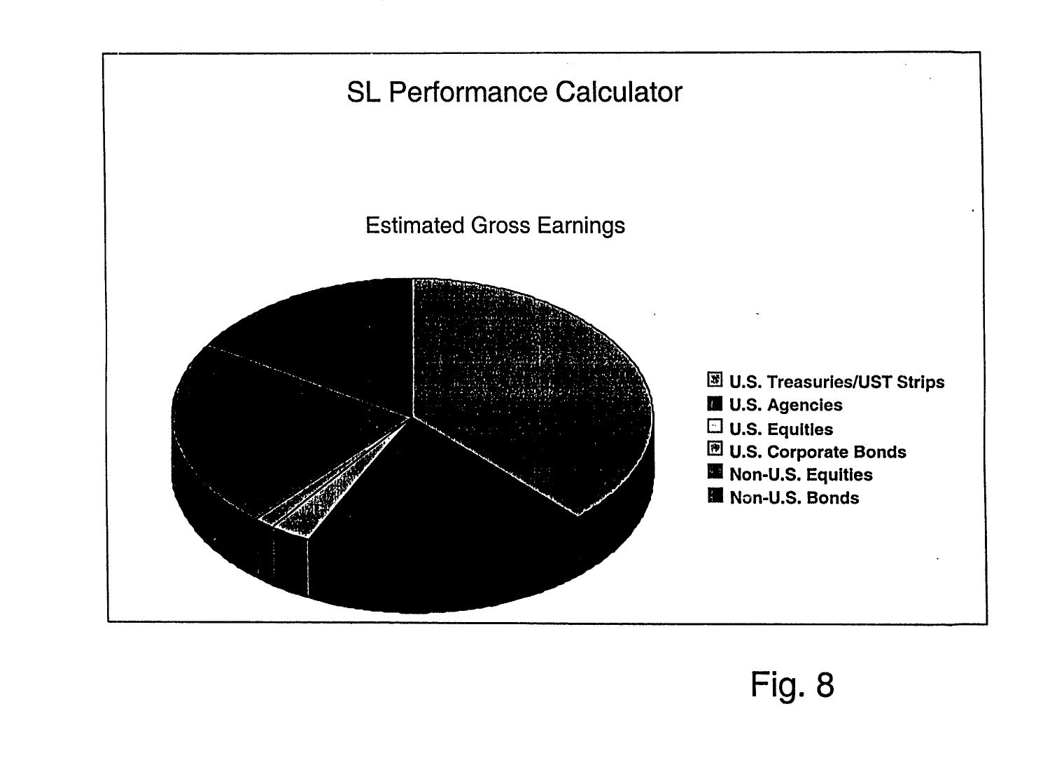

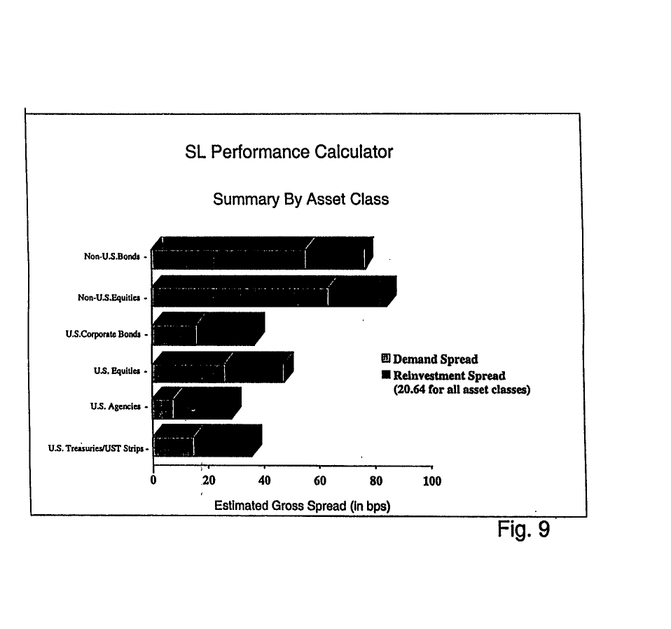

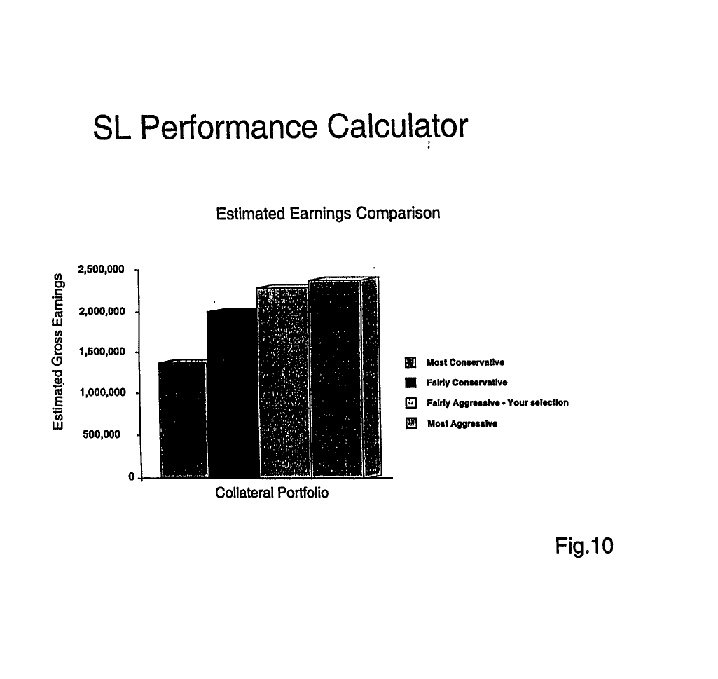

Once the profile is created the earnings estimator module 44 may process the profile to generate an estimate of the earnings that that particular profile of securities assets could possibly generate in a securities lending program. Once this information is calculated, the earnings estimator module 44 can calculate and estimate earnings and present that estimate through an HTML page, such as the HTML page 52 depicted in FIG. 7. Additional screens, shown in FIGS. 8, 9 and 10 present other information to the subscriber 22. This information includes a screen that shows the estimated gross earnings for each type of security within the subscriber's profile. Additionally, a graphical representation of the gross spread by asset type may also be presented. This can include, as is done in FIG. 9, a breakdown of the spread that illustrates the portion of the gross spread that arises from the demand spread and the portion of the gross spread that arises from the reinvestment of the collateral. Additionally and optionally, the system may generate an HTML page that allows the user to visualize and compare estimates of earnings for different levels of risk. The information provided by these screens allows the subscriber to readily see the relative earning power of each of the asset types in the subscriber's portfolio, as well as the relative earnings that may be achieved based on the subscriber's 22 tolerance for risk.

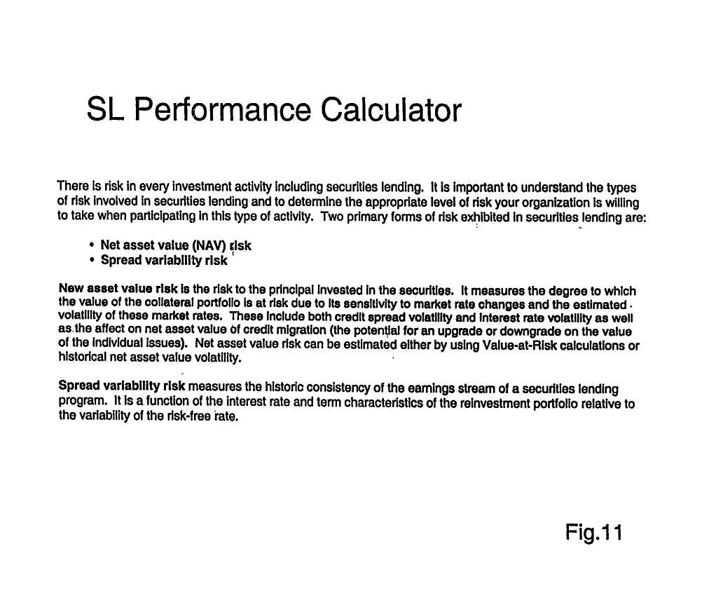

Once the subscriber has been presented with the information in FIGS. 8, 9 and 10, the system 20 can allow a subscriber to examine more closely the risk involved with participating in a securities lending program for that subscriber's portfolio. Thus, the systems and methods described herein provide the subscriber with a visual representation of risk. To this end, the system 20 can generate a splash screen, shown in FIG. 11, that advises the subscriber of the types of risk involved in such a transaction.

For the depicted screen of FIG. 11, the system 20 describes to the subscriber that there is risk in every investment activity including securities lending. The types of risk involved in securities lending include risk to net asset value, and risk arising from spread variability. Net asset value risk is the risk to the principal invested in the securities. It measures the degree to which the value of the cash collateral portfolio is at risk due to its sensitivity to market rate changes and the estimated volatility of these market rates. These include both credit spread volatility and interest rate volatility as well as the affect on net asset value of credit migration (the potential for an upgrade or downgrade on the value of the individual issues). Spread variability risk measures the historic consistency of the earnings stream of a securities lending program. It is a function of the interest rate and term characteristics or the reinvestment portfolio relative to the variability of the rebate rate.

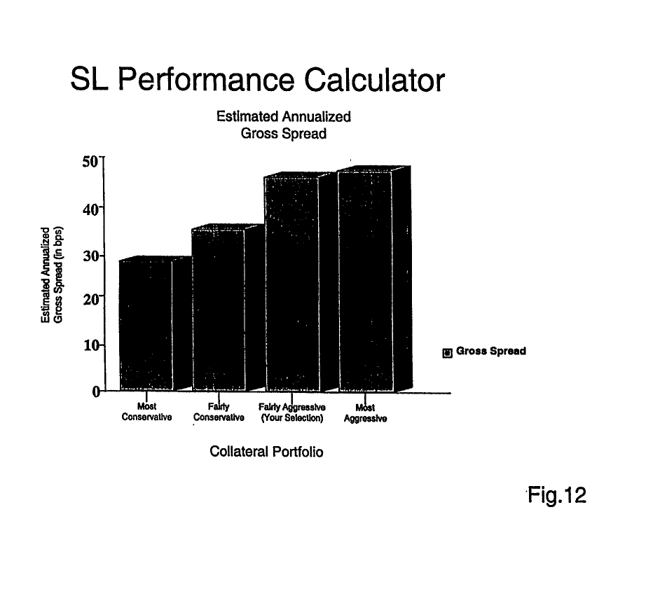

Once the subscriber has been advised of the types of risks involved in a securities lending transaction, the system 20 provides a screen, shown in FIG. 12, that presents an estimate of the total risk. This total risk can be determined by combining the risk to the net asset value with the spread variability risk. The risk is presented to the subscriber in terms of basis points at risk during the course of a year.

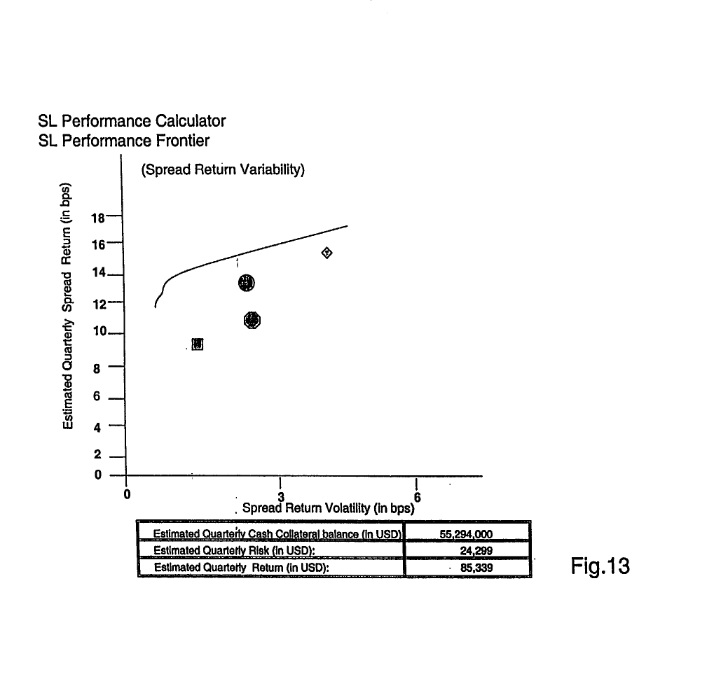

Additionally, the system 20 can also include a module that allows a subscriber that has participated in a securities lending transaction to see the risk and return that arose during the subscriber's collateral reinvestment transaction, in comparison to the risk and return that arose during transactions undertaken by other participants. To this end, the module can generate a plot of efficient frontiers, as a function of the spread, volatility of spread, total return and volatility of total return of the collateral reinvestment portfolios. The plotted efficient frontier will be representative of the optimal performance that could have been achieved by a subscriber given the investment vehicles possible. Examples of such plots are set forth in FIGS. 13, 14, 15 and 16. These plots may be generated by the module and formatted into HTML documents that may be served by the system 20 to the subscriber.

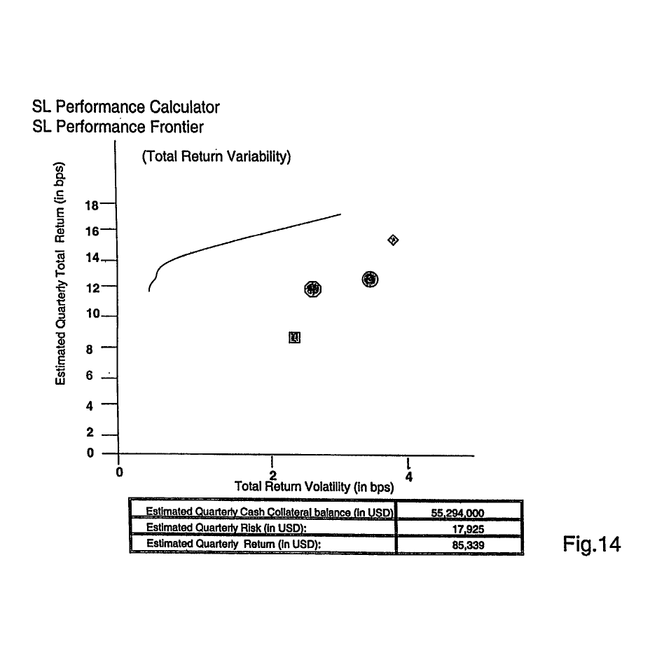

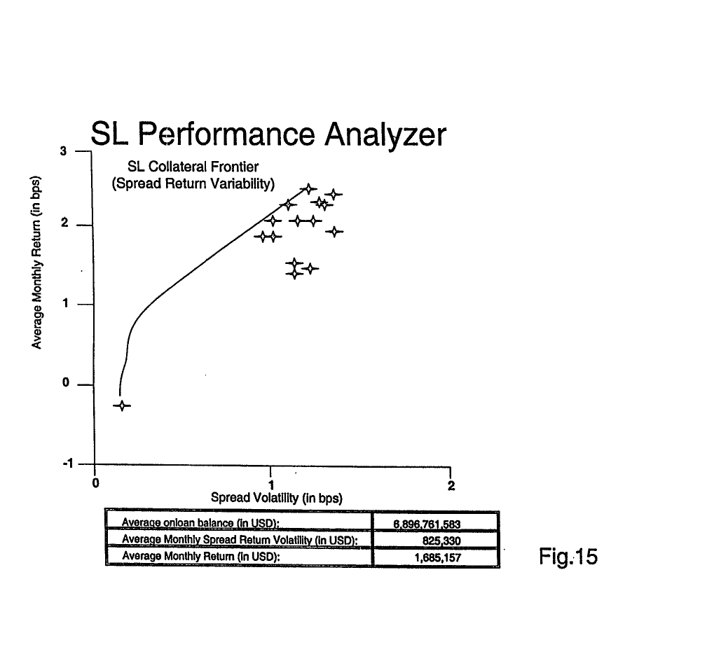

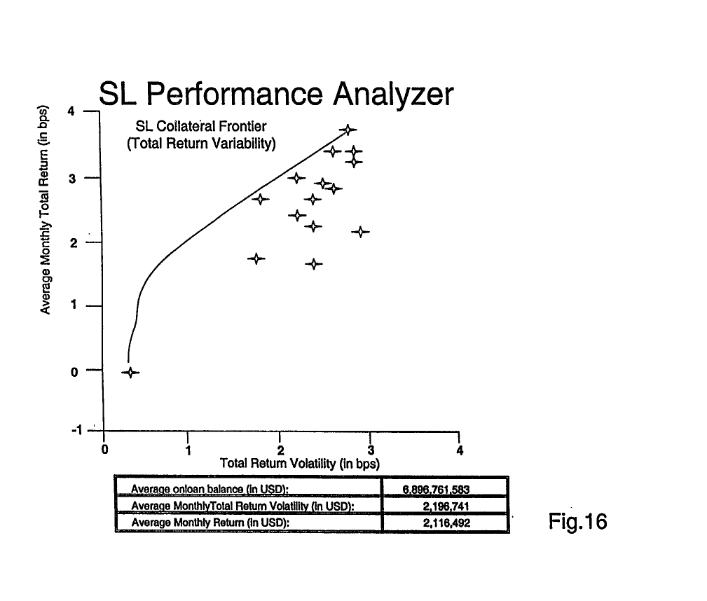

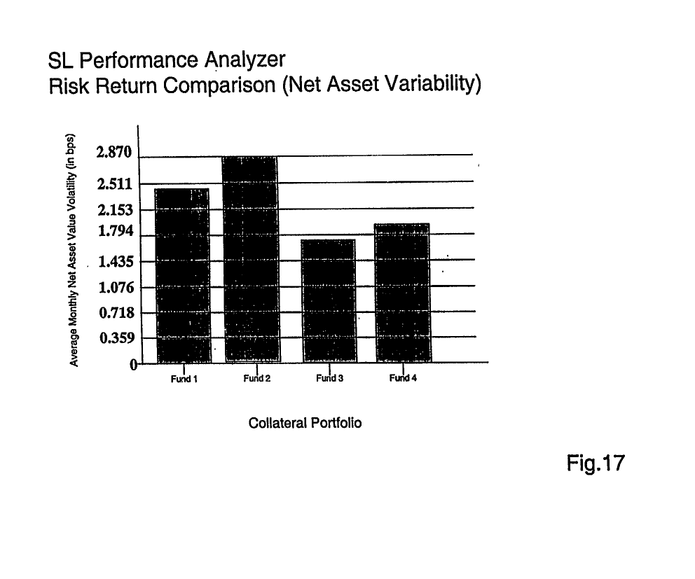

In the depicted examples of FIGS. 13, 14, 15 and 16, the system 20 plots the efficient frontier and actual collateral investment portfolios using the y-axis for the expected return, i.e., mean historical spread, or estimated quarterly or monthly return, and the x-axis for the risk, i.e., spread return or total return volatility. Specifically, FIG. 13 plots on the y-axis the estimated quarterly spread return (in basis points) produced from the gross spread for the securities lending integrated portfolio. FIG. 13 plots on the x-axis the spread return volatility (in basis points) for the securities lending integrated portfolio. FIG. 14 plots on the y-axis the estimated quarterly total return (in basis points) for the securities lending integrated portfolio and the x-axis plots the total return volatility (both in basis points). FIG. 15 plots on the y-axis the average monthly return (in basis points) produced from the spread for the investment vehicles. FIG. 15 plots on the x-axis the spread volatility (in basis points) for the investment vehicles. FIG. 16 plots on the y-axis the average monthly total return and the x-axis plots the total return volatility (both in basis points). FIG. 17 plots the monthly net asset value volatility (in bps) for the specified collateral portfolio as well as other commingled collateral portfolios.

The collateral reinvestment spread may be understood, in one practice, as the spread between the weighted average collateral yield and weighted average risk free rate.

In one practice, the collateral reinvestment spread is plotted on the y-axis and determined through the following analysis:

Collateral Reinvestment Spread=Ra−Rf,

Where Ra=Yield of the Reinvestment Vehicle and Rf=Risk Free Rate.

The yield of the reinvestment vehicles can be provided on a monthly basis, quarterly basis or for any suitable time period. The yield can be an average yield, a mean yield or any other suitable measure. The risk free rate is typically, but not limited to, the federal funds effective rate or the U.S. Government overnight repurchase rate.

Demand Spread=Rf−Rrebate; and

Integrated Spread=Collateral Reinvestment Spread+Demand Spread=Ra−Rf+Rf−Rrebate=Ra−Rrebate;

Spread Return Variability of the collateral=sigma (Ra, rf)

Where sigma represents the standard deviation of the reinvestment collateral spread.

Estimated returns may be determined from reviewing historical returns on investments and return from demand spread. These measures may be employed to plot the frontier.

The graph created will provide, inter alia, an integrated view of the efficient frontier. FIGS. 13, 14, 15 and 16 provide examples of such graphs. Specifically, FIG. 15 depicts a graph that illustrates the collateral frontier, wherein the subscriber can see the estimated return versus the spread return volatility for the investment vehicle selected by that subscriber and for the other available investment vehicles. This graph can allow the subscriber to alter the investment vehicle selected after an analysis of the risk and return characteristics of the available investments. FIG. 16 presents a similar graph that includes in the risk analysis the risk present for the NAV of the investment. In this way, the subscriber can compare the spread risk versus spread return as well as the total risk versus the total return.

Once presented with the information shown in FIGS. 7 through 14, a subscriber is more capable of making informed decisions about a securities lending program. These graphs and the system 20 may be part of a suite of risk-adjusted return products for a securities lending agent. These tools provide a comprehensive risk-adjusted reporting mechanism enabling more effective risk-based marketing to existing and prospective clients and client service. These tools enable clients and prospects to visually see the various collateral reinvestment options available along the risk-return spectrum. The challenge in discussing collateral reinvestment options with clients and prospects is detailing the two ways that they can realize risk in their portfolio, either through net asset value risk or return volatility risk. Thus, the systems described herein help in this client education process.

The system 20 that supports these tools can be developed using conventional hardware platforms. For example, the depicted data processing system that supports the server 24 and the modules can be a conventional data processing platform such as an IBM PC-compatible computer running the Windows operating systems, or a SUN workstation running a Unix operating system. Additionally, much of the software may be conventional software including standard software systems for providing a front-end interface. To this end, the front end in one embodiment can comprise a conventional web server that uses conventional web programming and that serves and generates web pages for interacting with the subscribers. The design and development of such front end systems follows from techniques generally known in the art including techniques described in Graham, HTML Sourcebook, Wiley Computer Publishing (1997), the teachings of which are herein incorporated by reference.

Moreover, although FIGS. 2 and 3 graphically depict the system 20 as comprising functional block elements, it will be apparent to one of ordinary skill in the art that these elements can be realized as computer programs or portions of computer programs. Such programs will be capable of running on the data processor platform to configure the data processor as a system according to the invention. Additionally, although FIG. 2 depicts the system 20 as an integrated unit, it will be apparent to those of ordinary skill in the art that this is only one embodiment, and that the invention can be embodied as separate computer programs that can operate separate processors.

As discussed above, the risk/return analyzer described above can be realized as a software component operating on a conventional data processing system such as a Unix workstation. In that embodiment, the mechanism can be implemented as a C language computer program, or a computer program written in any high level language including C++, Fortran, Java or basic. The techniques for the development of such programs are known to those of skill in the art, and set forth in, for example, Stephen G. Kochan, Programming in C, Hayden Publishing (1983).

The depicted databases can be any suitable database system, including the commercially available Microsoft Access database, and can be a local or distributed database system. The design and development of suitable database systems are described in McGovern et al., A Guide To Sybase and SQL Server, Addison-Wesley (1993). The databases can be supported by any suitable persistent data memory, such as a hard disk drive, RAID system, tape drive system, floppy diskette or any other suitable system. The system depicted in FIGS. 2 and 3 includes a database device 26 that is separate from the server 24. However, it will be understood by those of ordinary skill in the art that in other embodiments the database device 26 can be integrated into the system 24.

Those ordinarily skilled in the art will know, or be able to ascertain using no more than routine experimentation, many equivalents to the embodiments and practices described herein. Accordingly, it will be understood that the invention is not to be limited to the embodiments disclosed herein, but is to be understood by the following claims which are to be interpreted as broadly as allowed under the law.

We claim:

1. A process for presenting to a security holder a representation of a risk/return spectrum for an investment of collateral delivered as part of a securities lending transaction, comprising
allowing the security holder to create a profile representative of an allocation of securities assets among a set of predefined securities assets classes,
allowing the security holder to identify a tolerance for risk for an investment of cash collateral delivered as part of a securities lending transaction,
determining, as a function of the created profile, the amount of collateral that may be obtained from lending the securities assets, and
determining as a function of the identified tolerance for risk and the amount of collateral, an estimated earnings value representative of an estimate of earnings that may be obtained by investing the amount of collateral.

2. The process according to claim 1, further comprising
generating a graphical image of the estimate of earnings for presenting to the security holder a visual representation of the estimate of earnings.

3. The process according to claim 2, further comprising
formatting the graphical image into a file format suitable for delivery over a computer network to thereby allow presentation of the visual representation on a remote client.

4. A process according to claim 1, further comprising
determining a portion of the estimated earnings that arises from demand spread.

5. A process according to claim 1, further comprising
determining a portion of the estimated earnings that arises from reinvestment.

6. A process according to claim 1, further comprising
generating estimated earning values for a number of risk tolerances that are used to provide a graphical image that presents a comparison of estimated earnings as a function of risk tolerance.

7. A process according to claim 6, further comprising
identifying for a selected risk tolerance, a set of collateral reinvestment vehicles having risk factors consistent with the selected risk tolerance.

8. A process according to claim 7, further comprising
determining as a function of the identified set of collateral reinvestment vehicles a net asset value risk representative of the risk to the collateral invested.

9. A process according to claim 7, further comprising
determining as a function of the identified set of investments a spread risk representative of the risk associated with the return on the identified collateral reinvestment vehicles.

10. A process according to claim 1, further comprising
determining an efficient frontier representative of the optimum return versus risk performance achievable from a plurality of collateral reinvestment vehicles.

11. A process according to claim 10, further comprising
generating a graphical representation of the efficient frontier for providing the security holder with a visual representation of the optimum return versus risk performance.

12. A process according to claim 11, further comprising
depicting with the graphical representation of the efficient frontier a set of points representative of the return versus risk performance for a collateral reinvestment vehicle available to the security holder.

13. A process according to claim 1, wherein determining the amount of collateral that may be obtained from lending the securities assets includes
accessing a database of aggregated industry information for securities lending transactions to determine empirically the amount of collateral that may be obtained.

14. A web-based system for allowing a security holder to analyze risk relating to the investment of cash collateral in a securities lending transaction, comprising
a web server for providing a user interface that allows the security holder to create a profile representative of an allocation of securities assets among a set of predefined assets classes, and for allowing the security holder to identify a tolerance for risk for an investment of collateral delivered as part of a securities lending transaction,
a database having a history of securities lending transactions,
a collateral processor for employing the history of securities lending transactions to process the created profile and thereby determine the amount of collateral that may be obtained from lending the securities assets, and
an earnings processor for determining, as a function of the identified tolerance for risk and the amount of collateral, an estimated earnings value representative of an estimation of earnings that may be obtained by investing the amount of collateral.

15. A web-based system for auctioning securities for a securities lending transaction, comprising
a web server for providing creating a marketplace for allowing security holders to disclose a portfolio of securities available to be borrowed and for determining a demand measure for measuring demand for certain securities,
a user interface for allowing the security holder to indicate a tolerance for risk,
a collateral processor for employing the demand measure to determine the amount of collateral that may be obtained from lending the securities assets and a value representative of demand spread for the securities, and
an earnings processor for determining, as a function of the identified tolerance for risk and the amount of collateral, an estimated earnings value representative of an estimate of earnings that may be obtained by investing the amount of collateral, whereby the security holder may employ the determined earnings to determine whether to accept an offer for a security.

16. A computer readable medium having stored there instructions for directing a computer system to perform a process for presenting to a security holder a representation of a risk/return spectrum for an investment of collateral delivered as part of a securities lending transaction, the instructions comprising
allowing the security holder to create a profile representative of an allocation of securities assets among a set of predefined asset classes,
allowing the security holder to identify a tolerance for risk for an investment of collateral delivered as part of a securities lending transaction,
determining, as a function of the created profile, the amount of collateral that may be obtained from lending the securities assets, and
determining as a function of the identified tolerance for risk and the amount of collateral, an estimated earnings value representative of an estimation of earnings that may be obtained by investing the amount of collateral.
